(19) United States
(12) Patent Application Publication
(10) Pub. No.: US 2009/0260949 A1
(43) Pub. Date: Oct. 22, 2009

(54) Ski lift having an auxiliary conveyor floor

(76) Inventor: Manfred Huber, Worgl (AT)

Correspondence Address: DILWORTH & BARRESE, LLP, 1000 WOODBURY ROAD, SUITE 405, WOODBURY, NY, 11797, US

(21) Appl. No.: 12/380,256

(22) Filed: Feb. 25, 2009

(30) Foreign Application Priority Data
Feb. 26, 2008 (DE) UM 202008002698.9

(51) Int. Cl. B66B 29/08

(52) U.S. Cl. 198/324

(57) ABSTRACT

The present invention relates to a passenger transportation system, in particular a ski lift system in the form of a chair lift system or a circulating gondola lift system, having a main conveyor, in particular a chair lift or a circulating gondola lift, having a boarding/disembarking platform to board and/or alight from the main conveyor moving past the boarding/disembarking platform as well as having an auxiliary conveyor in the form of a conveyor floor for the conveying of persons to and/or from the boarding/disembarking platform. It is proposed in accordance with the invention that the conveyor floor describes a curved conveyor path which includes a first conveyor path section which feeds to the boarding platform or feeds away from the disembarking platform at an acute angle inclined to the conveying direction of the main conveyor and a second conveyor path section which extends substantially parallel to the conveying direction of the main conveyor at the boarding platform.

### BACKGROUND OF THE INVENTION

The present invention relates to a passenger transportation system, in particular a ski lift system in the form of a chair lift or circulating gondola lift system, having a main conveyor, in particular a chair lift or a circulating gondola lift, having a boarding/disembarking platform to board and/or alight from the main conveyor moving past the boarding/disembarking platform as well as having an auxiliary conveyor in the form of a conveyor floor for the conveying of persons to and/or from the boarding/disembarking platform.

In ski lift systems of the named type, as a rule circulating conveyors, for example in the form of a chair lift or of a circulating gondola lift, are used to achieve high passenger conveying rates. A problem to be solved here, however, is the boarding of the circulating conveyor or the disembarking therefrom since as a rule high circulation speeds have to be operated to achieve the high conveying rates. To combat this problem, in modern systems the passenger carrying means, i.e. the chairs or gondolas, are decoupled from the circulating conveyor cable in the boarding and disembarking zone and are moved through the boarding zone at a conveying speed reduced with respect to the conveyor cable. However, this takes place in part at a still substantial speed to prevent the conveying rate from falling too much. Apart from this, there is still a plurality of older circulating lifts, in particular in the form of chair lifts, which cannot decouple in the boarding and disembarking region so that it is necessary to board or disembark from the chair moving through the boarding zone at full conveying speed.

To alleviate this problem, it has therefore already been proposed to use an auxiliary conveyor in the form of a conveyor floor in the boarding and disembarking zone, said conveyor floor, on the one hand, conveying the boarding passengers into the boarding zone and conveying disembarking persons out of the disembarking zone and, on the other hand, reducing the speed difference to the circulating conveyor. Such conveyor floors are as a rule made for ski lift systems in the form of endless plastic belts having an adhesively attached snow carpet or in the form of an endless rubber belt whose lateral extent is monitored by belt misalignment monitors to ensure a straight running of the band.

Such auxiliary conveyor floors conventionally require, however, sufficient space in the boarding and disembarking zone of the chair lift or of the circulating gondola lift to merge the passengers to be conveyed in or out between the more or less closely sequential chairs or cabins. Particularly with older chair lift systems, but also with circulating gondola lifts, this space is, however, not always present. In particular when the cable is caught or attached directly behind the reversing wheel of the circulating conveyor by means of tensioning weights positioned there, it is not possible to guide a sufficiently long conveyor floor from behind in the conveying direction into the boarding zone or, with crossways boarders, transversely to the conveying direction of the main conveyor below its reversing wheel.

### SUMMARY OF THE INVENTION

Starting from this, it is the underlying object of the present invention to provide an improved passenger conveying system, in particular a ski lift system, of the initially named type which avoids disadvantages of the prior art and further develops the latter in an advantageous manner. A simple and safe boarding should also in particular be achieved under tight space relationships in the region of the boarding platform of the chair lift or of the circulating gondola lift.

This object is solved in accordance with the invention by a passenger conveying system described herein. Preferred embodiments of the invention are also described herein.

It is therefore proposed to guide the auxiliary conveyor floor so-to-say around the corner or bend so that the passengers to be conveyed can be transported to or from the boarding zone over a sufficiently long conveyor floor distance of practically any direction despite the boarding or disembarking direction predetermined by the direction of conveying of the circulating conveyor for passengers. It is proposed in accordance with the invention that the conveyor floor describes a curved conveyor path which includes a first conveyor path section which runs toward the boarding platform or feeds away from the disembarking platform at an acute angle inclined to the conveying direction of the main conveyor and a second conveyor path section which extends substantially parallel to the conveying direction of the main conveyor at the boarding platform. Due to the conveying in or out of the passengers along a curve, a sufficiently long auxiliary conveyor path can also be realized under tight space conditions by means of which the passengers to be conveyed can be conveyed safely, matching the cycle of the incoming gondolas, from a starting point disposed sufficiently far outside the danger zone into the boarding zone or conversely can be conveyed out. The conveyor path of the conveyor floor moves laterally into the conveying region of the main conveyor and then a little further parallel to the direction of conveying of the main conveyor to ensure a problem-free boarding and disembarking.

The curve segment of the conveyor floor can in this respect be made differently in size with respect to the radius of curvature and/or to the angle swept over. Generally, the curved path of the conveyor floor can sweep over any desired angle of sensible up to 180°. To give the passengers to be conveyed the feeling instinctively of boarding correctly and in order, on the other hand, not to exert accelerations which are too high, provision can be made in an advantageous further development of the invention that the previously named first conveyor section runs toward or away from the named main conveyor inclined at an angle of approximately 20° up to 60°, preferably approximately 30°, to the conveyor path of the main conveyor. A good compromise is hereby achieved between a fast leading to or leading away, on the one hand, and low centrifugal forces onto the passengers standing on the conveyor floor, on the other hand.

Due to the slanted running in and then curved pivoting inward to the main conveying direction of the main conveyor, the actual boarding or disembarking point can also be selected almost independently of the reversal point of the main conveyor made as a circulating conveyor under tight space conditions. In accordance with an advantageous embodiment of the invention, the conveyor floor can be spaced apart from a reversal point of the main conveyor in the direction of conveying of the main conveyor, can in particular be arranged outside the effective region of the reversing carousel of the main conveyor, which can in particular be of advantage with older chair lifts which have a cramped terminal building in which the reversing carousel and tensioning weights are arranged. Due to the curved design of the auxiliary conveyor, the boarding platform can be provided spaced some meters away from the reversing carousel in the direction of conveying since the auxiliary conveyor is guided in laterally irrespective of the cramped space conditions at the reversing carousel and is then pivoted inward in the direction of conveying of the main conveyor.

In accordance with an alternative, likewise advantageous embodiment of the invention, the conveyor floor can, however, also be arranged in the reversal region of the main conveyor, with provision in particular being able to be made that the arcuate or curved conveyor path section of the conveyor floor follows the reversal path of the main conveyor. In a particularly advantageous further development of the invention, the curved conveyor path of the conveyor floor can be adapted to the curvature or the extent of the arcuate conveyor path of the main conveyor in its reversal region so that the conveyor floor follows the passenger carrier means guided around the reversing carousel substantially parallel. This can also be used, as required, to utilize the reversal region of the main conveyor as a boarding zone or as a disembarking zone so that reversal terminals of particularly compact construction without protruding separate boarding or disembarking zones can be provided. Such a curved conveyor path of the auxiliary conveyor can in particular be of advantage with circulating gondola lifts which provide a reversal arc for the circulating gondolas which is per se very large. The passengers conveyed on the conveyor carpet or conveyor floor can hereby board or disembark from the circulating gondolas without problem during the reversal procedure.

The boarding zone of the conveyor floor can generally be arranged at different distances and/or in different directions from the main conveyor. An advantageous embodiment of the invention can in this respect consist of the fact that a boarding zone of the conveyor floor is arranged laterally, i.e. transversely to the main direction of conveying of the main conveyor, spaced apart from its conveyor path outside the travel track of the passenger carrying means of the main conveyor. In this respect the passengers in the first conveyor path section of the conveyor floor are guided to the passenger carrier means so-to-say transversely to the main axis of the main conveyor. If the conveyor floor is used as a disembarking aid, in an advantageous further development of the invention, the disembarking zone of the conveyor floor can generally be arranged in a corresponding manner at different distances and/or spaced apart in different directions from the main conveyor, with the disembarking zone of the conveyor floor advantageously being arranged laterally, i.e. transversely to the main direction of conveying of the main conveyor, spaced apart from its conveyor path outside the travel track of the passenger carrying means of the main conveyor. In this respect the passengers in the corresponding conveyor path section of the conveyor floor are guided away from the passenger carrier means of the main conveyor so-to-say transversely to the main axis of the main conveyor

The different conveyor path sections of the conveyor floor can generally be made differently. The conveyor floor can, for example, consist completely of curved or curvy conveyor path segments, if required, it can also lead to the main conveyor in S shape. In a preferred further development of the invention, however, the conveyor floor can have a respective straight extent in the previously named first and second conveyor path sections, with these two straight conveyor path sections being able to be connected to one another by a third, curved conveyor path section. In this respect, it can, for example, be advantageous in conjunction with a chairlift as the main conveyor if the first and second conveyor path sections of the conveyor floor are each made at least twice as long as the third, curved conveyor path section.

Instead of such a so-to-say kinked conveyor floor extent having two straight conveyor path sections and a curved conveyor path section disposed therebetween, the conveyor floor can, however, also have the extent of a continuous trajectory which approaches the direction of conveying of the main conveyor gently and uniformly and, conversely, leads away from it laterally.

When the main conveyor is made in the form of a chair lift, provision is advantageously made that the previously named second conveyor track section of the conveyor floor extends beneath the conveyor path of the chair. In this respect, a speed difference can be provided between the conveyor floor speed and the chair lift speed which allows a comfortable, but nevertheless speedy boarding and disembarking. The conveyor floor speed can advantageously be approximately 25% to 65%, preferably approximately 30% to 40% of the chair lift speed in the boarding zone. In the disembarking zone, in contrast, a conveyor belt can be provided having a speed of approximately 125% to 165%, preferably approximately 130% to 140%, of the chair lift speed.

When the main conveyor is made as a circulating gondola lift, provision can advantageously be made that the previously named second conveyor path section of the conveyor floor extends parallel next to the travel track swept over by the circulating gondolas, with provision in particular also being able to be made here that this conveyor path section extending in parallel extends in a curved fashion along the reversing carousel or along the reversal track of the circulating gondolas. Provision is advantageously made in this respect that no difference in speed or only a slight difference in speed is provided between the speed of the circulating gondolas and the speed of the conveyor floor to ensure a comfortable boarding into the circulating gondolas or disembarking from the circulating gondolas.

The conveyor floor can generally be designed differently, with a conveyor band advantageously being able to be provided in the form of a curved link belt. The conveyor band can preferably include overlapping tread plates which are rotatably journaled around an upright axis of rotation so that they can be guided around the curve and in so doing can be rotated relative to one another.

Tread plates in the form of crescent-shaped plate segments whose bulging or concave rim segments overlap one another pairwise are particularly advantageous with respect to simple construction, on the one hand, and only slight moving over one another, on the other hand, which could effect a pulling in or displacement of the foot standing thereon. A secure footing for passengers is achieved by such shingle-like tread plates, and indeed both of skiers who are standing on the conveyor surface with skis and of pedestrians who enter the lift without skis or with an unfastened snowboard.

In a preferred further development of the invention, the named tread plates are in this respect guided displaceably and rotatably with their coupling pieces journaling them rotatably in a guide which defines the conveyor path of the conveyor floor.

Advantageously in this respect, an angular control device is associated with the tread plates by means of which the angular position of the tread plates along the conveyor path of the conveyor floor is controlled substantially parallel to the longitudinal axis of the conveyor path or parallel to a tangent adjacent to it. The named angular control device can in this respect, for example, include control levers which have a lever arm opposite the coupling pieces defining the axis of rotation and which are likewise guided at the guide at which the named coupling pieces run. Alternatively or additionally, the tread plates themselves could have a suitable guide nose or similar guide elements which are spaced part from the axis of rotation and control the tread plate angles. The tread plates can in particular be guided longitudinally displaceably with two coupling pieces, by means of which a respective preceding tread plate and a respective trailing tread plate can be hingedly coupled, in a guide defining the conveyor path so that the angular alignment is so-to-say adopted automatically in accordance with the conveyor path.

The drive of the conveyor floor can generally have different designs. In a preferred embodiment of the invention, the conveyor floor drive comprises, in the case of tread plates, drive wheels which are in engagement with the lower side of the tread plates. In this respect, a shape-matched engagement is advantageously provided, with in particular drive wheels being able to be provided in the form of gears or pinions which engage into toothed-rack-like notches or recesses in the lower side of the tread plates. A shape-matched connection for power transmission hereby arises. At the same time, the link belt is guided laterally so that the drive satisfies a dual function and separate lateral guide links can be dispensed with.

Alternatively or additionally to such drive wheels, the drive apparatus can also include endlessly circulating, pliable drive means which can in particular be made as a round link chain. Alternatively, flexible belts can also circulate endlessly as driving means.

Such pliable pulling means can advantageously be coupled to the lower side of the tread plates to transmit the drive movement to the tread plates. It would also be feasible to drive other link belts accordingly.

In accordance with a further advantageous embodiment of the invention, the conveyor floor can also have a curved link belt whose links are hingedly connected to one another around transverse axes and are coupled to one another in a tensile force transmitting manner in the manner of a chain, with the links having sufficient play with respect to the transverse axes in the length direction of the belt in order to make the links sufficiently rotatable with respect to one another around an axis perpendicular to the conveyor floor plane and to make the link belt curved. In this case, the link belt itself so-to-say forms a pliable band-like pulling means which can be driven in an endlessly circulating manner in a suitable manner and forms a conveyor carpet. The links of this link belt can advantageously form strip-like tread webs which are hingedly coupled to one another like a chain in the named manner. To avoid a misaligned running or warping of the link belt, individual links or all the links can preferably be guided at their lateral rims in elongate guides, for example in the form of dragging webs or sliding webs.

### BRIEF DESCRIPTION OF THE DRAWINGS

The invention will be explained in more detail in the following with respect to preferred embodiments and to associated drawings. There are shown in the drawings:

FIG. 1: a plan view of the boarding zone of a chair lift system having a conveyor floor in accordance with a preferred embodiment of the invention leading in curved form to the boarding zone of the chair lift;

FIG. 2: an elevation of the boarding zone of the chair lift system of FIG. 1;

FIG. 3: a plan view of the disembarking zone of the chair lift system from the preceding Figures in which a conveyor floor is provided which leads out of the disembarking zone like an arc.

FIG. 4: an elevation of the disembarking zone of the chair lift system of FIG. 3;

FIG. 5: a plan view of the boarding/disembarking zone of a circulating gondola lift having a conveyor floor guided around the reversing region of the circulating gondola lift like an arc;

FIG. 6: an elevation of the boarding/disembarking zone of the chair lift system of FIG. 5;

FIG. 7: a section-wise plan view of the tread plates of the conveyor floor from the preceding Figures;

FIG. 8: a section-wise side view of the tread plates of FIG. 7 and their coupling pieces by means of which the tread plates are guided;

FIG. 9: a cross-section through one of the tread plates from the two preceding Figures and their journaling and guidance on the tread plate lower side; and

FIG. 10 a section-wise perspective representation of a curved link belt which can be used in accordance with a further embodiment of the invention for the conveyor floor from the preceding FIGS. 1 to 6.

### DESCRIPTION OF THE PREFERRED EMBODIMENTS

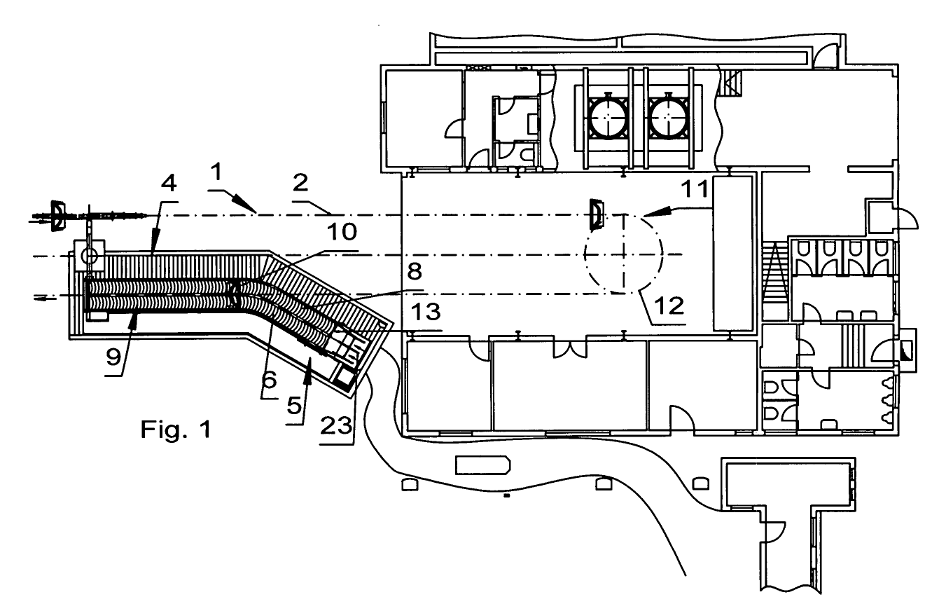

FIG. 1 shows the lower terminal of a chair lift system. The chair lift 2 forming the main conveyor 1 comprises a circulating carrier cable or conveyor cable which is deflected in the terminal building 2 by means of a reversal device 11, more precisely by means of a reversing carousel 12.

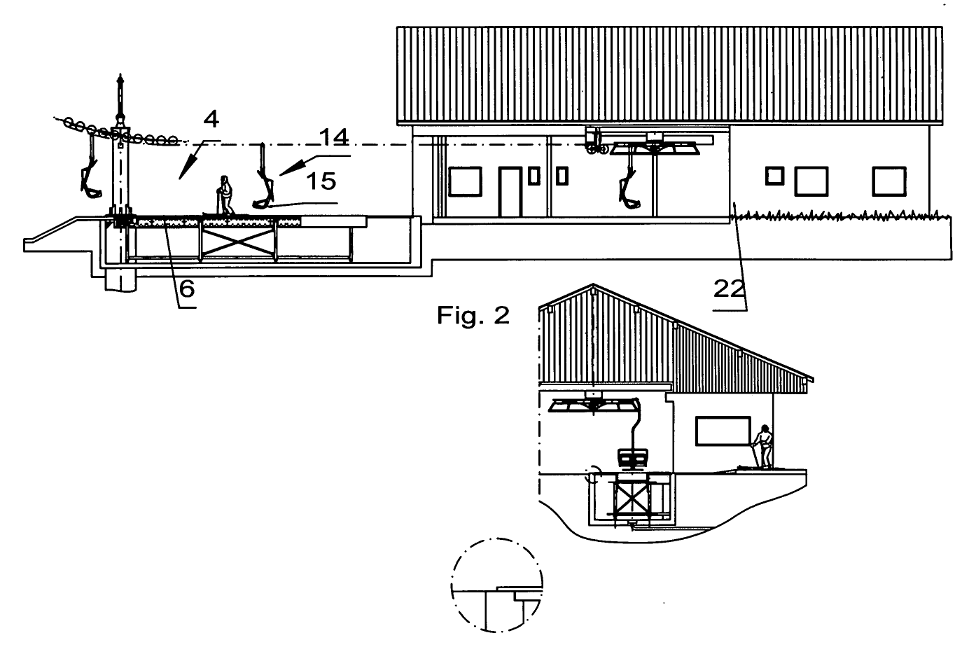

In the embodiment shown, the boarding zone for the boarding of the chair lift 2 is arranged outside the named terminal building 22. A boarding/disembarking platform 4 is arranged beneath the run of the carrier cable running downhill and is matched vertically to the chair lift 2 such that its passenger carrier means 14 run in the form of the chair 15 at a suitable level over the boarding platform 4, cf. FIG. 2.

In this respect a conveyor floor 6, which describes a curved conveyor path 7, as FIG. 1 shows, is associated with the named boarding/disembarking platform 4 as an auxiliary conveyor 5 for the transport of the passengers. The access region of the conveyor floor 6 is disposed laterally outside, i.e. transversely spaced apart, from the travel track of the chair lift 2 swept over by the chair 15. A first conveyor path section 8 of the conveyor floor 6 leads at an acute angle to the conveyor track of the chair lift 2 leading uphill, with the named first conveyor path section 8 of the conveyor floor 6 in the embodiment shown running toward the chair lift 2 at an angle of approximately 30° to the direction of conveying thereof, cf. FIG. 1. This first conveyor path section 8 therefore leads slantingly to the boarding region or to the boarding/disembarking platform 4 on which the conveyor floor 6 then extends parallel to the direction of conveying of the chair lift 2. This second conveyor path section 9 of the conveyor floor 6 is connected to the previously named first conveyor path section 8 via a third curved conveyor path section 10 so that overall the conveyor floor is made curved such that it initially runs slantingly toward the conveyor track of the chair lift 2, then bends in a curve to the direction of conveying of the chair lift 2 and finally extends a little further parallel to the direction of conveying of the chair lift 2 under its downhill running cable run. No space is required in the region of the terminal building 22 due to this lateral running in of the conveyor floor 6 around the curve, which is in particular of advantage when cramped space relationships are present in the region of the reversal carousel 12, as FIG. 1 shows.

The access to the boarding zone of the conveyor floor 6 is in this respect regulated via a boarding divider 23 known per se which, for example, comprises a hydraulically or electrically actuable barrier. The boarding divider 23 can in this respect be built on a support construction which is fixedly connected to the conveyor floor 6. The conveyor floor is assembled at a spacing of approximately one meter from the boarding divider 23, with a run-in ramp being installed at a suitable inclination of approx. 5 to 10% between the conveyor floor and the boarding divider 23.

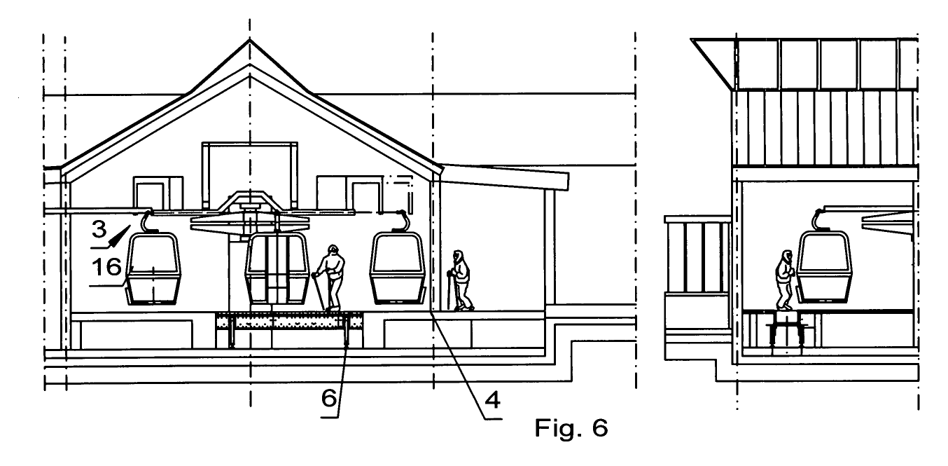

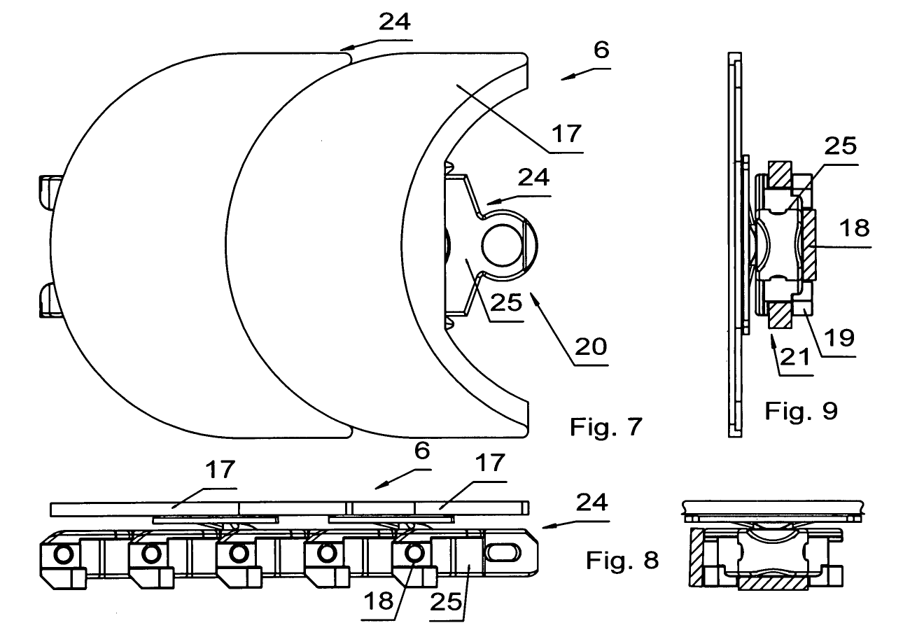

The conveyor floor 6 can advantageously, as FIGS. 7 to 9 show, have a link belt 24 which has a plurality of tread plates 17 which are made in the embodiment drawn in the form of crescent-shaped plate segments, cf. FIG. 7. These crescent-shaped tread plates 17 overlap one another with their arcuate edges, with the concavely arched rim side advantageously running ahead and being covered by the bulging rear side of the preceding tread plate. The tread plates 17 can have a width of 10 to 70 cm, preferably approx. 15 to 30 cm, and a length of approx. 50 cm to 150 cm, preferably approx. 70 to 90 cm. The tread plates 17 have coupling pieces 25 at their lower side which have eyelet-shaped connection pieces in the embodiment drawn. Adjacent tread plates 17 are connected to one another by means of these eyelet-like connection pieces, with corresponding connection rods being able to be inserted into eyelets overlapping into one another, whereby an endless tread plate band can be installed.

The tread plates 17 can advantageously be guided longitudinally displaceably in a guide 19 disposed on the lower side of the tread plates 17 by means of the named coupling pieces 25, with the named guide 19 describing and defining the previously described curved extent. The tread plates 17 are in this respect rotatable around upright axes of rotation 18 so that they can be guided parallel to the conveyor path 7 of the conveyor floor 6 parallel to a tangent hereto. For this purpose, an angle control device 20 is provided at the lower side of the tread plate 17 and can, for example, include guide levers which are guided to the named guide 19. The tread plates 17 can advantageously also be angle controlled in that they are guided at two respective coupling pieces 25 since each tread plate 17 is respectively coupled, on the one hand, to the preceding tread plate 17 and, on the other hand, to the trailing tread plate 17 so that two guide points result for each tread plate 17, cf. FIG. 8.

As FIG. 1 shows, in accordance with the embodiment drawn, a plurality of tread plate bands can be arranged next to one another so that, for example, two conveyor tracks can be provided from the conveyor floor 6 with a two-chair lift.

A pinion drive is provided as the conveyor floor drive 21 in the embodiment drawn and includes drive wheels which engage at the lower side of the tread plates 17 and which are advantageously made in the form of gears which engage in notches or recesses at the lower side of the tread plates 17. A shape-matched connection for power transmission hereby arises. The tread plate band 17 is simultaneously laterally guided. Gears are likewise located at the reversal side. The diameter of the drive units or reversing units can hereby be minimized.

Alternatively or additionally to such a drive pinion, the drive apparatus can also include endlessly circulating, pliable drive means which can in particular be made as a round link chain. Alternatively, flexible belts can also circulate endlessly as driving means. Such pliable pulling means can advantageously be coupled to the lower side of the tread plates 17 to transmit the drive movement to the tread plates 17.

To ensure tread safety on the tread plates 17, they can be provided at their surface with a suitable anti-slip structure, for example in the form of a roughened surface structure.

The conveyor belt of the conveyor floor 6 formed by the treat plates 17 is advantageously guided centrally in a compulsory manner so that a lateral extent of the conveyor belt is impossible. This can be achieved by the guide 19 in which the coupling pieces 25 run.

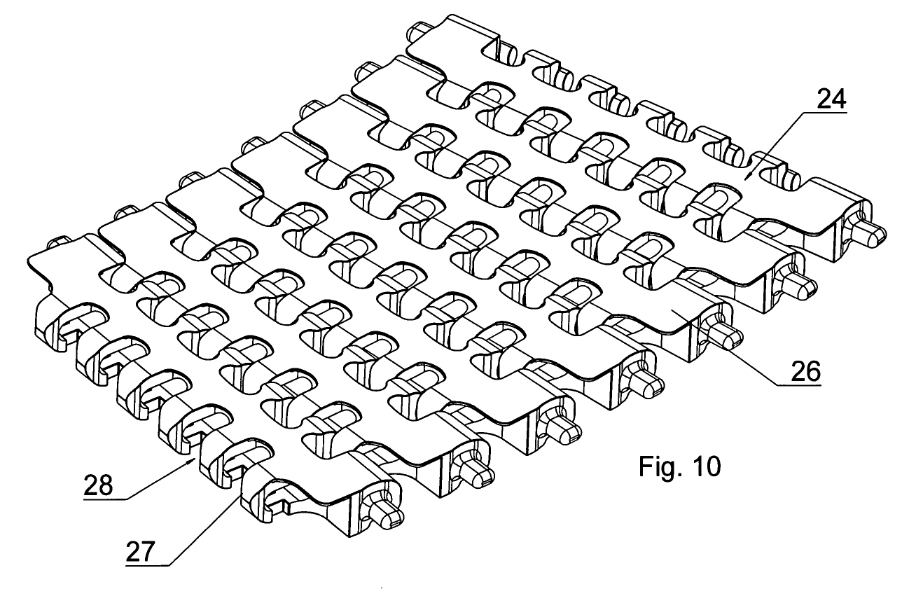

In accordance with a further advantageous embodiment of the invention which FIG. 10 shows, instead of such tread plates 17 the conveyor floor can also have a curved link belt 24 whose links 26 hingedly connected to one another around transverse axes and are coupled to one another in a tensile force transmitting manner in the manner of a chain, with the links 26 having sufficient play with respect to the transverse axes in the length direction of the belt in order to make the links 26 sufficiently rotatable with respect to one another around an axis perpendicular to the conveyor floor plane and to make the link belt 24 curved. In this case, the link belt 24 itself so-to-say forms a pliable band-like pulling means which can be driven in an endlessly circulating manner in a suitable manner and forms a conveyor carpet. The links 26 of this link belt 24 can advantageously form strip-like tread webs which are hingedly coupled to one another like a chain in the named manner. In this respect, the named links 26 can advantageously have pivot noses 27 which are arranged in the manner of a comb and which engage into pivot recesses 28 which are provided at the respective next link and which are likewise disposed in rows next to one another in a corresponding manner in the transverse direction of the link belt. Each link 26 can in particular have pivot noses 27, on the one hand, and pivot depressions 28 complementary thereto, on the other hand, which are offset to one another in the transverse direction by a division step so that pivot noses 27 and pivot depressions 28 can engage into one another in the manner of a comb, as FIG. 10 shows. In this respect, suitable shape-matched engagement means, for example in the form of pivot pins and pivot pin pockets, can be provided at the pivot noses and pivot depressions and realize the desired flexibility around the transverse axis and the play in the longitudinal direction which in turn effects the curvedness of the link belt 24. To avoid a misaligned running or warping of the link belt, individual links or all the links can preferably be guided at their lateral rims in elongate guides, for example in the form of dragging webs or sliding webs.

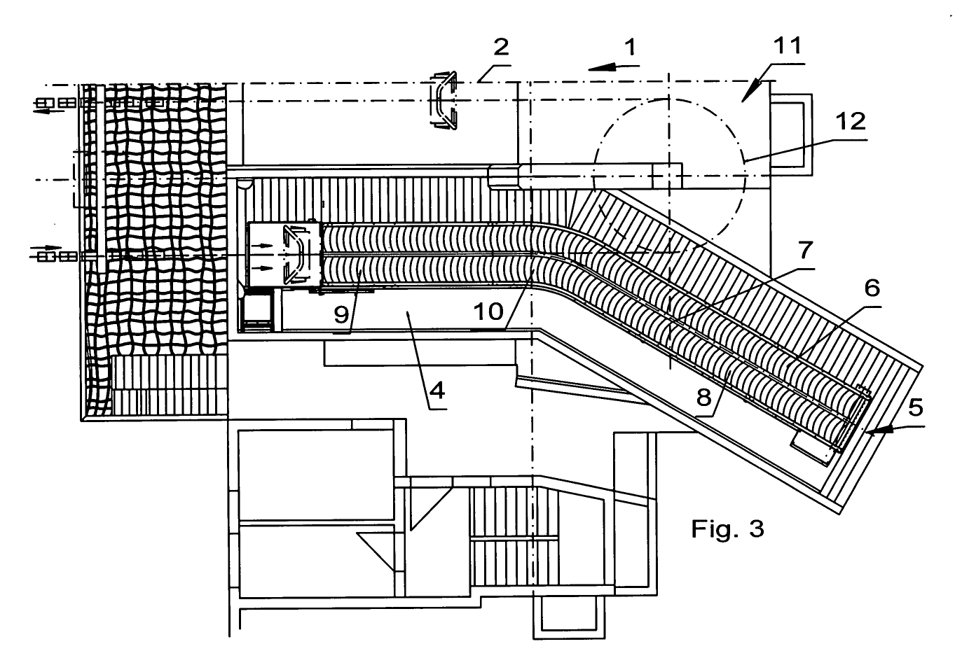

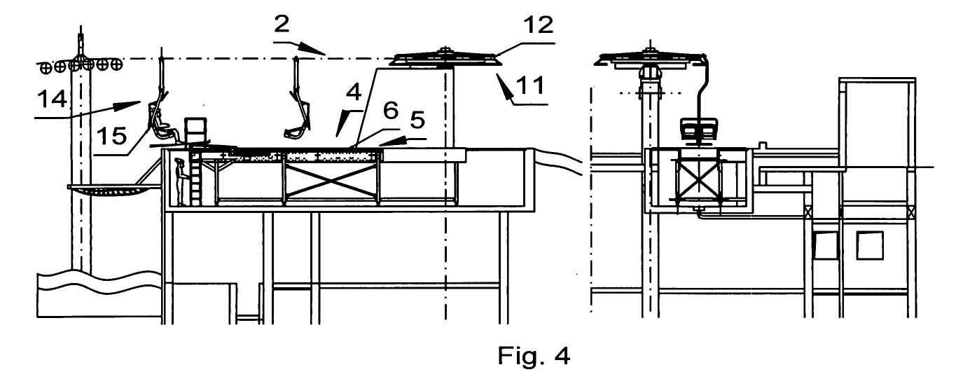

In FIGS. 1 and 2, the conveyor floor 6 is mounted in the boarding zone of the chair lift 2 as a boarding aid. As FIGS. 3 and 4 show, such a curved conveyor floor 6 can also be of advantage in the disembarking zone of the chair lift 2. In this respect, a correspondingly formed conveyor floor 6 is mounted so-to-say kinematically reversed. The conveyor floor 6 initially extends parallel under the chair lift 2 on the disembarking platform 4 so that the chair lift passengers can board onto the co-moving conveyor floor 6 at an exact match. This then leads laterally out of the conveyor path of the chair lift 2 with a curved conveyor path section 9. The conveyor floor 6 guides the skiers or passengers safely out of the operational area of the chair lift 2 by means of a straight conveyor floor section inclined at an acute angle to the direction of conveying of the chair lift 2. In this respect, the conveyor floor 6 advantageously leads past the reversing carousel of the chair lift 2 so that the region of the upper terminal surrounding the reversing carousel 12 is not needed for the disembarking of the passengers.

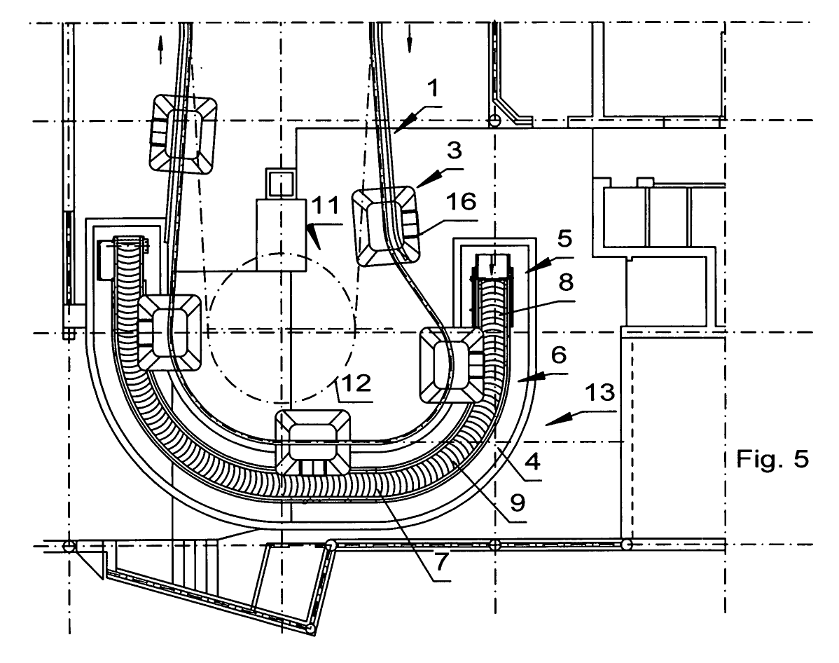

As FIGS. 5 and 6 show, a curvedly angled conveyor floor 7 can also advantageously be used as a boarding aid and/or disembarking aid for a circulating gondola lift 3. As FIG. 5 shows, provision can advantageously be made that the conveyor floor 6 is guided arcuately around the reversal region of the circulating gondola lift 3 so that the conveyor floor 6 follows the conveyor path of the circulating gondolas 16 at least section-wise in the reversal region. The conveyor floor 6 can in particular be matched to the conveyor path of the circulating gondolas 16 such that the conveyor floor 6 runs laterally next to the gondolas 16 so that passengers standing on the conveyor floor 6 can fasten skis or snowboards to the gondolas circulating in the reversing region without problem and can then board the gondolas. Conversely, passengers can disembark from the circulating gondolas on the co-moving conveyor floors without having to start running straight away on disembarking and to remove skis or snowboards fastened to the circulating gondolas from the circulating gondolas while standing on the conveyor floor.

The conveyor floor 6 advantageously also has a boarding section here which runs at an acute angle toward the conveyor path of the circulating gondolas so that the passengers are automatically led to the boarding zone of the circulating gondolas, cf. FIG. 5, and/or to a disembarking section which leads away from the disembarking zone of the circulating gondolas and which leads away from the conveyor path of the circulating gondolas at an acute angle.

1. A passenger transportation system, in particular a ski lift system in the form of a chair lift system or of a circulating gondola lift system, having a main conveyor (1), in particular a chair lift (2) or a circulating gondola lift (3), having a boarding/disembarking platform (4) for the entering and/or exiting of the main conveyor (1) moving past the boarding/disembarking platform (4), as well as having an auxiliary conveyor (5) in the form of a conveyor floor (6) for the conveying of passengers to or from the boarding/disembarking platform (4), wherein the conveyor floor (6) has a curved conveyor path (7) which includes a first conveyor path section (8) which runs slantingly to the direction of conveying of the main conveyor (1) toward the boarding/disembarking platform (4) or leads away from the boarding/disembarking platform (4), as well as having a second conveyor path section (9) which extends substantially parallel to the direction of conveying of the main conveyor (1) at the boarding/disembarking platform (4).

2. A passenger transportation system in accordance with claim 1, wherein the first conveyor path section (8) runs toward the main conveyor (1) or leads away from it slantingly at an angle of 20° to 60°, preferably approximately 30°, to the conveyor axis of the main conveyor (1).

3. A passenger transportation system in accordance with claim 1, wherein the conveyor floor (6) is spaced apart from a reversal device (11), in particular a reversal carousel (12) of the main conveyor (1) in the direction of conveying of the main conveyor (1), is in particular arranged outside the operational area of the reversal carousel (12) of the main conveyor (1).

4. A passenger transportation system in accordance with claim 1, wherein the conveyor floor (6) is arranged in the reversing region of the main conveyor (1) and follows the arcuate reversing path of the main conveyor (1).

5. A passenger transportation system in accordance with claim 4, wherein the conveyor path (7) of the conveyor floor (6) is matched to the arcuate reversing path of the main conveyor (1) and extends in parallel at least section-wise to the named arcuate reversing path of the main conveyor (1).

6. A passenger transportation system in accordance with claim 1, wherein a boarding zone (13) of the conveyor floor (6) is spaced apart laterally from the conveyor path of the main conveyor (1) arranged outside the travel track of the passenger carrier means of the main conveyor (1), in particular its chairs (15) or circulating gondolas (16), and/or extends inclined to the conveyor path of the main conveyor.

7. A passenger transportation system in accordance with claim 1, wherein the first and second conveyor path sections (8, 9) of the conveyor floor (6) each have a straight extent and are connected to one another by a third, curved conveyor path section (10).

8. A passenger transportation system in accordance with claim 7, wherein the first and second conveyor path sections (8, 9) are each at least twice as long as the named third, curved conveyor path section (10).

9. A passenger transportation system in accordance with claim 1, wherein the named second conveyor path section (9) of the conveyor floor (6) extends beneath the conveyor path of the chair lift (2) on the formation of the main conveyor (1) as a chair lift (2).

10. A passenger transportation system in accordance with claim 9, wherein a conveyor speed difference is provided between the conveyor floor (6) and the chair lift (2), with the conveyor speed of the conveyor floor (6) in the embarking zone in particular being 25% to 65%, preferably approximately 30% to 40%, of the conveyor speed of the chair lift and the conveyor speed of the conveyor floor (6) in the disembarking zone being 125% to 165%, preferably approximately 130% to 140%, of the conveying speed of the chair lift.

11. A passenger transportation system in accordance with claim 1, wherein the aforesaid second conveyor path section (9) of the conveyor floor (6) extends laterally next to the conveyor path of the circulating gondola lift on formation of the main conveyor (1) as a circulating gondola lift.

12. A passenger transportation system in accordance with claim 11, wherein the conveyor speed of the conveyor floor (6) substantially corresponds to the conveyor speed of the circulating gondola lift.

13. A passenger transportation system in accordance with claim 1, wherein the conveyor floor (6) includes mutually overlapping tread plates (17) which are rotatably journaled around upright axes of rotation (18) by rotatably journaled coupling pieces.

14. A passenger transportation system in accordance with claim 13, wherein the mutually overlapping tread plates (17) form a link band and/or are part of a link band.

15. A passenger transportation system in accordance with claim 13, wherein the tread plates (17) are formed by crescent-shaped plate segments.

16. A passenger transportation system in accordance with claim 1, wherein the tread plates are displaceably guided in a guide (19) defining the conveyor path (7) of the conveyor floor (6).

17. A passenger transportation system in accordance with claim 1, wherein an angle control device (20) is associated with the tread plates (17) by means of which the angular position of the tread plates (17) along the conveyor path 87) of the conveyor floor (6) is controlled substantially parallel to the conveyor path longitudinal axis or to a tangent adjacent to the conveyor path.

18. A passenger transportation system in accordance with claim 1, wherein the conveyor floor (6) has a conveyor floor drive (21) which includes drive wheels arranged at the lower side of the tread plates (17).

19. A passenger transportation system in accordance with claim 18, wherein the drive wheels of the conveyor floor drive are made in the form of gears which mesh with a rack-like engagement section of the tread plates and/or form a lateral guide for the tread plates.

20. A passenger transportation system in accordance with claim 1, wherein the conveyor floor (6) has endlessly circulating, pliable drive means, preferably in the form of a round link chain.

21. A passenger transportation system in accordance with claim 13, wherein the conveyor floor (6) has endlessly circulating, pliable drive means, preferably in the form of a round link chain and the pliable drive means are connected to the tread plates (17) at the lower side thereof.

22. A passenger transportation system in accordance with claim 1, wherein the conveyor floor (6) has a curved link belt (24) whose links (26) are pivotally connected to one another around transverse axes and are coupled to one another in the manner of a chain in manner transmitting tensile force, with the links (26) having play with respect to the transverse axes in the longitudinal direction of the belt by means of which the links (26) are rotatable with respect to one another around an axis perpendicular to the conveyor floor plane and the link belt (24) is curved.
